(19) United States
(12) Patent Application Publication
(10) Pub. No.: US 2008/0039549 A1
(43) Pub. Date: Feb. 14, 2008

(54) Two-Part Printing System with Acrylic-Based Polymers

(76) Inventors: Jun Li, Lexington, KY (US); Ajay Kanubhai Suthar, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/427,828

(22) Filed: Jun. 30, 2006

(51) Int. Cl. C09D 11/00

(52) U.S. Cl. 523/160; 523/161

(57) ABSTRACT

The present invention relates to a print media product comprising a substrate having at least one ink receiving layer and a pigment-based inkjet composition. The ink receiving layer of the substrate is comprised of a first acrylic based polymer A. The pigment-based ink jet ink composition comprises a pigment and a second acrylic-based polymer B. The acrylic-based polymers A and B have a strong affinity for each other and act as a two part system to improve the smear resistance of the pigment-based ink composition when printed on the ink receiving layer of the substrate.

### TECHNICAL FIELD

The present invention relates to a two-part ink-media system to improve smear resistance of pigment-based inks on polymer-based photo paper.

### BACKGROUND OF THE INVENTION

Ink jet printing is a non-impact method of printing that involves ejecting ink from a nozzle onto paper or other print media. The actual ink ejection method may occur via several processes including pressurized nozzles, electrostatic fields, piezoelectric elements within an ink nozzle, and heaters for vapor phase bubble formation.

The composition of the ink is traditionally comprised of deionized water, a water soluble organic solvent, and a colorant. The colorant may be a soluble dye or insoluble pigment. Several problems, however, are associated with soluble dyes that are not applicable to insoluble pigments. These problems include poor water-fastness, poor light-fastness, poor thermal stability, facile oxidation, dye crystallization, and ink bleeding and feathering on the print medium. To circumvent these problems, use of a pigment as the colorant is preferred. Pigments generally have better light-fast and water-fast properties, are more resistant to oxidation, and have higher thermal stability.

Use of a pigment instead of an aqueous dye presents solubility problems since the pigments are in soluble in aqueous media. As a result, the insoluble pigment is generally stabilized in a dispersion by a polymeric dispersant.

Smear resistance on photo paper, especially on gelatin paper, is a significant problem for pigment-based inks. Most gelatin paper is designed for use with dye-based inks. When a pigment-based ink is printed onto a gelatin photo paper, the solvents will penetrate into the paper and later evaporate into the environment. Pigment and the polymeric dispersant will loosely pack on the paper surface. The packaged pigment-dispersant cake has only a weak adhesion on the paper surface, and weak smear resistance has often been observed.

By changing ink or photo paper formulation, many methods have been disclosed in the past to improve smear resistance. For example, US 20040102541 disclosed graft polymeric dispersants in pigment-based inks to increase smear resistance; US 20050166794 disclosed using a dispersed cellulose ester as a binder additive in pigment-based inks to enhance the durability of the printed images; US 20050134665 disclosed ink additives that contains benzyl methacrylate to increase smear resistance. US 2005011856, U.S. Pat. No. 6,020,397, and U.S. Pat. No. 6,503,307 disclosed some imaging fixing components (reactive liquids) to improve abrasion resistance. On the other hand, U.S. Pat. Nos. 6,844,035, 6,689,433, and 6,528,148 disclosed the use of a poly(vinyl alcohol polyethylene oxide) copolymer and other binders in polymer-based photo papers to improve smear-fastness.

One may notice that these inventions mentioned above and many other earlier inventions only focus on providing solutions by changing either the ink or the photo paper formulation. Applicants have found that when changing the ink or the photo paper formulation alone, the resulting ink-media compatibility may not be improved enough to provide the desired smear resistance.

It is an object of the present invention to provide a two-part system by changing both the ink and photo paper formulation to improve the ink-media compatibility and therefore provide excellent photo smear resistance.

### SUMMARY OF THE INVENTION

The present invention provides a two-part ink-media system to improve smear resistance of pigment-based inks on polymer-based photo paper. In particular, a specific acrylic-based polymer A is used as a photo paper coating/additive, and another acrylic-based polymer B is used in the pigment-based ink composition as a dispersant/additive.

The invention, in one form thereof, is directed to a print media product comprising a substrate and a pigment-based inkjet composition. The print media product substrate comprises at least one ink receiving layer supported by the substrate. The ink receiving layer of the substrate is comprised of a first acrylic-based polymer A. The pigment-based ink jet ink composition comprises a pigment and a second acrylic-based polymer B. The acrylic-based polymers A and B have a strong affinity for each other and act as a two part system to improve the smear resistance of the pigment-based ink composition when printed on the ink receiving layer of the substrate.

In a preferred embodiment, the substrate of the print media product is a polymer-based photo paper The first acrylic-based polymer A is preferably coated on the polymer-based photo paper. The coating thickness of the first acrylic-based polymer A is from about 5 μm to about 15 μm.

The first acrylic-based polymer A is an emulsion and has a molecular weight above 200,000, an acid number of from about 200 to about 250, and a Tg of from about −30° C. to 100° C. A preferred acrylate-based polymer A includes styrene acrylate with acid functional group containing diene monomer. The polymer is typically made by emulsion polymerization and has high molecular weight.

The second acrylic-based polymer B is water-soluble and has a molecular weight of from about 1,000 to about 20,000, an acid number of from about 200 to about 250, and a Tg from about 50° C. to about 150° C. The second acrylic-based polymer B can be used as an acrylic dispersant or as an additive in the pigment-based ink composition.

Preferably the second acrylic-based polymer B comprises from about 0.2% to about 5%, more preferably from about 0.5% to about 3% by weight of the pigment-based inkjet ink composition.

All percentages and ratios, used herein, are “by weight” unless otherwise specified. All molecular weights, used herein, are weight average molecular weights unless otherwise specified. Further details and advantages of the present invention are set forth below in the following more detailed description.

### DETAILED DESCRIPTION OF THE INVENTION

The present invention provides a two-part ink-media system to improve smear resistance of pigment-based inks on polymer-based photo paper. In particular a specific acrylic-based polymer A is used as a photo paper coating/additive, and another acrylic-based polymer B is used in the pigment-based ink composition as a dispersant/additive.

Smear resistance on photo paper, especially on gelatin paper, is a significant problem for pigmented inks comprising a pigment dispersion. Most gelatin paper is designated for use with dye based inks. When conventional pigmented inks are printed on gelatin based paper, the pigmented dispersion remains on the surface of the gelatin coating and is susceptible to smearing or smudging.

The invention, in one form thereof, is directed to a print media product comprising a substrate and a pigment-based inkjet composition. The print media product substrate comprises at least one ink receiving layer supported by the substrate. The ink receiving layer of the substrate is comprised of a first acrylic based polymer A. The pigment-based ink jet ink composition comprises a pigment and a second acrylic-based polymer B. The acrylic-based polymers A and B have a strong affinity for each other and act as a two part system to improve the smear resistance of the pigment-based ink composition when printed on the ink receiving layer of the substrate.

The pigment-based inkjet compositions of the present invention comprise the second acrylic-based polymer B, an insoluble pigment, and an aqueous carrier. A wide variety of organic and inorganic pigments, alone or in combination, may be selected for use in the aqueous inks of the present invention. The key selection criterion for a pigment are that it must be dispersible in the aqueous medium with the aid of the second acrylic-based polymer B and optionally, with the aid of additional dispersants. The term “pigment”, as used herein, means an insoluble colorant (including organic and inorganic pigments). The selected pigment may be used in dry or wet form.

The second acrylic-based polymer B is water-soluble and has a molecular weight of from about 1,000 to about 20,000, an acid number of from about 200 to about 250, and a Tg from about 50° C. to about 150° C. The second acrylic-based polymer B can be used as an acrylic dispersant or as an additive in the pigment-based ink composition.

The second acrylic-based polymer B of the present invention includes block and/or graft co- or terpolymers comprising a hydrophilic polymeric segment, and one or two hydrophobic polymeric segment(s). The hydrophobic segment tends to interact with the pigment particle in the ink compositions and the hydrophilic segment tends to be solvated by the aqueous medium thereby dispersing the pigment. Generally, the second acrylic-based polymer B can be prepared with ethylenically unsaturated monomers, initiators, and optionally with surfactants, alkali, and water or another reaction solvent. Exemplary monomers include, but are not limited to, acrylic acid, methacrylic acid, styrene, methyl styrene, butyl acrylate, ethyl methacrylate, 2-ethyl hexyl acrylate, methyl methacrylate etc. Those skilled in the art will readily appreciate that the mixture of monomers may be varied as necessary to tailor the polymer to the particular application.

In one embodiment of the present invention, a specific acrylic-based water-soluble polymer, Joncryl HPD 671 acrylic resin from Johnson Polymer (Sturtevant, Wis.), was used as a dispersant for the pigment-based ink. Some physical properties of Joncryl HPD 671 are listed in Table 1 below.

TABLE 1
Typical physical properties of Joncryl HPD 671

| | |
|---|---|
| Appearance | Clear Flakes |
| Non-Volatile | 99.4% |
| MW | 17,000 |
| Density | 1.14 g/cc |
| Tg | 128° C. |
| Acid Number | 214 (NV) |

The pigment-based inkjet composition of the present invention comprise from about 0.1% to about 10%, more preferably from about 2% to about 6% of an insoluble pigment, from about 0.2% to about 5%, more preferably from about 0.5% to about 3% by of the second acrylic-based polymer B described above, and an aqueous carrier. The pigment to second acrylic-based polymer B (weight) ratio is preferably about 2:1, but may vary from about 1:1 to about 15:1 of pigment to polymer B.

Suitable pigments include organic and inorganic pigments of a particle size sufficient to permit free flow of the ink through the ink jet printing device, especially at the ejecting nozzles that usually have a diameter ranging from about 10 microns to 50 microns. Thus, a suitable pigment particle size is from about 0.05 to about 15, preferably from about 0.05 to about 5, and more preferably from about 0.05 to about 0.5, microns. Pigments suitable for use in the present invention include azo pigments, such as azo lakes, insoluble azo pigments, condensed azo pigments and chelate azo pigments, polycyclic pigments, perylene pigments, anthraquinone pigments, quinacridone pigments, dioxazine pigments, thioindigo pigments, isoindolinone pigments, quinophthalone pigments, and dry lakes. Suitable organic pigments include nitro pigments, nitroso pigments, aniline black and daylight fluorescent pigments. Preferred pigments include carbon black, Pigment Red 122, Pigment Red 202, Pigment Yellow 74, Pigment Yellow 128, Pigment Yellow 138, Pigment Yellow 155, Pigment Blue 15:3 and Pigment Blue 15:4.

The third component of the aqueous ink compositions of the present invention is the aqueous carrier medium which is generally present at from about 70% to about 99% of the composition. The aqueous carrier medium comprises water (preferably deionized water) and, preferably, at least one water soluble organic solvent. Selection of a suitable carrier mixture depends on the requirements of the specific application involved, such as desired surface tension and viscosity, the selected pigment, the desired drying time of the ink, and the type of paper onto which the ink will be printed. Representative examples of water soluble organic solvents that may be selected include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols, such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, diethylene glycol, triethylene glycol, proplylene glycol, tetraethylene glycol, polyethylene glycol, glycerol, 2-methyl-2,4-pentanediol, 1,2,6-hexanetriol and thiodiglycol; (6) lower alkyl mono- or di-ethers derived from alkylene glycols, such as ethylene glycol monomethyl (or monoethyl) ether, diethylene glycol monomethyl (or monoethyl) ether, propylene glycol monomethyl (or monoethyl) ether, triethylene glycol monomethyl (or monoethyl) ether and diethylene glycol dimethyl (or diethyl) ether; (7) nitrogen-containing cyclic compounds, such as pyrrolidone, N-methyl-2-pyrrolidone, and 1,3-dimethyl-2-imidazoli-dinone; and (8) sulfur-containing compounds, such as dimethyl sulfoxide and tetramethylene sulfone. Other useful organic solvents include lactones and lactams. Mixtures of these solvents may be used in the present invention.

The aqueous ink compositions of the present invention may further comprise a humectant mixture. Preferred humectants include, but are not limited to, bis-hydroxy terminated thioethers, lactams, and polyalkylene glycols. The amount of humectant in an ink formulation can range from 0 to 40 weight percent, preferably from 15 to 25 weight percent.

The ink compositions may further comprise surfactants to modify the surface tension of the ink and to control the penetration of the ink into the paper. Such surfactants are included in the ink compositions, and are not a component of the dispersant. Suitable surfactants include, but are not limited to, nonionic, amphoteric and ionic surfactants. Preferred surfactants include, but are not limited to, alkyl sulfate, nonyl phenyl polyethylene glycol, SILWET™, (OSI Sealants, Inc.), TERGITOL™, (Union Carbide) and SURFYNOL™, (Air Products and Chemicals, Inc.).

The ink compositions may optionally further comprise additional dispersants. The additional dispersants useful in this invention are generally not limited and include any of those capable of dispersing pigments. The dispersants typically comprise hydrophobic and hydrophilic polymeric segments. The hydrophobic segment tends to interact with the pigment particle in the ink compositions and the hydrophilic segment tends to be solvated by the aqueous medium thereby dispersing the pigment.

Illustrative examples of the additional dispersants which may be employed in the ink compositions of invention include AB, BAB and ABC block copolymers known in the art. Preferred AB and BAB block copolymers include those, for example, which comprise hydrophobic and hydrophilic segments derived from acrylic monomers. Another illustrative example of dispersants includes random polymers.

A preferred class of dispersants which may be employed in the present invention include block and/or graft co- or terpolymers comprising a hydrophilic polymeric segment, and one or two hydrophobic polymeric segment(s) having a hydrolytically stable siloxyl substituent or a hydrophobic amide side chain. A particularly preferred subgroup of these dispersants are graft terpolymers which comprise a hydrophilic polymeric segment (particularly an acrylic or methacrylic acid co- or terpolymer) together with a hydrophobic polymeric segment derived from a polyorganosiloxane as described in U.S. Pat. Nos. 5,719,204 and 5,714,538.

The ink composition of the present invention may also comprise a binder. The binder included in the ink compositions of the present invention is generally into limited so long as the binder has an ability to form a film. Typically the binder comprises an emulsion of acrylic resin, methacrylic resin, styrene resin, urethane resin, acrylamide resin, epoxy resin, or a mixture of these resins. The resin is not limited by copolymerization methods and may be, for example, a block copolymer, a random copolymer or the like.

In one embodiment, the binder comprises a latex polymer comprising the monomer units methyl methacrylate, butylacrylate, and methacrylic acid. In another embodiment, the binder comprises a latex polymer comprising the monomer units methyl methacrylate, butylacrylate, 2-hydroxyethyl methacrylate, and methacrylic acid. In another embodiment, the binder comprises a latex polymer comprising the monomer units methyl methacrylate, butyl acrylate, N-hydroxymethyl methacrylamide, and methacrylic acid. In another embodiment, the binder has a molecular weight between 150,000 and 300,000.

The amount of binder used in the inks of the present invention is limited by the binder's compatibility with the other components of the ink composition and its ability to reduce smearing of the ink. In an embodiment, the amount of binder included in the ink composition may range from about 0.1 to about 10% by weight. In another embodiment, the amount of binder in the ink composition ranges from about 1 to about 5% by weight.

Other additives, such as biocides, viscosity modifiers, penetrants, anti-kogation agents, anti-curling agents, chelating agents, anti-bleed agents, binders and buffers may be added to the ink composition at their art established levels. A preferred biocide includes, but is not limited to, Proxel™, GXL (Zeneca).

Application of the inkjet inks of this invention onto a print media substrate can be made by any suitable printing process compatible with the aqueous-based inks, such as flexographic printing, pen plotters, continuous stream inkjet printing, drop-on-demand inkjet printing (including piezoelectric, acoustic, and thermal inkjet processes), or the like. The inkjet ink compositions of this invention are extremely useful in the thermal inkjet printing process. The print substrate employed may be any print substrate compatible with aqueous-based inks, including plain papers, such as commercial bond papers; coated papers (or special inkjet papers), such as those available from Hewlett Packard, Kodak, Ilford, Canon, and Xerox Corporation; textiles; special inkjet papers, including silica coated papers and photorealistic inkjet papers; photographic papers; and inkjet transparency materials suitable for aqueous inks or inkjet printing processes.

The print media substrates of the present invention have at least one ink receiving layer supported by the substrate, with the ink supporting layer comprising a coating of the first acrylic-based polymer A. In a preferred embodiment, the first acrylic-based polymer A is coated on to a polymer-based photo paper substrate. The coating thickness of the first acrylic-based polymer A is from about 5 μm to about 15 μm.

The coating method may be any appropriate manufacturing procedures including, without limitation, roll-coating, spray-coating, immersion coating, cast-coating, slot-die coating, curtain coating, rod-coating, blade-coating, roller application, and other related production methods.

The first acrylic-based polymer A is an emulsion and preferably, has a molecular weight above 200,000, an acid number of from about 200 t about 250, and a Tg of from about −30° C. to 100° C. A preferred acrylic-based polymer A includes styrene acrylate with acid functional group containing diene monomer. The polymer is typically made by emulsion polymerization and has high molecular weight. The high molecular weight gives good binding strength, the acid functional group gives good stability, interaction with coating pigment and absorption of ink water and solvents. The acrylate has good interaction with dispersants in the ink.

The preparation of styrene acrylate emulsions is well known to those skilled in the art. For example, the preparation of emulsion polymers is described in Emulsion Polymerization by Gilbert, R. G., Academic Press, N.Y., 1995. They can be made by a continuous process as described in U.S. Pat. Nos. 4,546,160, 4,414,370, and 4,529,787 all of which are incorporated herein by reference. They can also be made as resin-supported emulsions prepared by aqueous phase polymerization in the presence of water-dispersible support resins as described in U.S. Pat. Nos. 4,894,397, 4,839,413, and 4,820,702, all of which are incorporated herein by reference. Generally such polymers are prepared with ethylenically unsaturated monomers, initiators, and optionally with surfactants, alkali, and water or another reaction solvent. Exemplary monomers include, but are into limited to, acrylic acid, methacrylic acid, styrene, methyl styrene, butyl acrylate, ethyl methacrylate, 2-ethyl hexyl acrylate, methyl methacrylate etc. Those skilled in the art will readily appreciate that the mixture of monomers may be varied as necessary to tailor the polymer to the particular application.

In one embodiment of the present invention, a specific acrylic-based polymer emulsion, Joncryl 660 Film Form Emulsion from Johnson Polymer (Sturtevant, Wis.), was coated on a polymer-based photo paper to provide a stronger adhesion force between the polymer-based photo paper and the pigment-dispersant layer. Some physical properties of Joncryl 660 are listed in Table 2 below.

TABLE 2
Typical physical properties of Joncryl 660

| | |
|---|---|
| pH | 8.5 |
| Non-Volatile | 32% |
| MW | >200,000 |
| Viscosity | 400 cps |
| Tg | 27° C. |
| Acid Number | 203 (NV) |

It was observed the Joncryl 660 is a unique acrylic-based polymer with its properties. All of the Film Form Emulsions from Johnson Polymer were tested, and only Joncryl 660 provided a stronger adhesion force between the polymer-based photo paper and the pigment-dispersant layer. A unique property of Joncryl 660 is that it has an Acid Number 203 (NV), while the acid numbers of all other Film Form Emulsions from Johnson Polymer are in the range of 20-135 (NV). On the other hand, generally the acrylic-based dispersants in pigment inks have an Acid Number above 200. It is believed that the acid content of these acrylic polymers is the dominant factor that determines the ink-media compatibility, and a similar acid content between Joncryl 660 and dispersant provides strong binding strength, while other polymer properties, such as MW or Tg, do not necessarily lead to high ink-media compatibility, and other acrylic-based polymers did not provide high smudge resistance for the pigment ink.

It is also observed that the thickness of the acrylic layer affects the smear resistance of pigment-based ink on such a layer coated polymer-based photo paper. Only within a proper range of the acrylic layer thickness (about 5-15 μm), can both short-term and long-term smear resistance of pigment-based ink be greatly improved. When the coating thickness is less than 5 μm, it is observed that the coating layer cannot provide enough binding strength and the ink smear resistance is low. On the other hand, when the coating thickness is more than 15 μm, the pigment ink dries slowly and the short-term smear resistance becomes worse.

It is also observed that the acrylic-based polymer A has good compatibility with current ink receiving layer materials of polymer-based photo paper. Therefore, it can be used as an additive/binder to the ink receiving layer materials during the manufacture of polymer-based photo paper. It should also be understood that the present invention should not be limited to any particular construction techniques (including any given material deposition procedures, layering arrangements, and the like) unless otherwise stated below. Within a proper range of concentrations, such an additive can provide both a high rub resistance of the paper itself and high smear resistance of pigment-based ink.

It is also observed that when the dispersants in the pigment-based inks is acrylic-based polymer B, or alternatively, when acrylic-based polymer B is used as an additive in the ink, these inks have excellent smear resistance on polymer-based photo paper. The acrylic-based polymer B should have an acid umber above 200 to have good compatibility with acrylic-based polymer A, and also should have Tg between 50 and 150° C. to provide sufficient scratch resistance, and molecular weight between 2,000 and 20,000. With the properties mentioned, such an acrylic-based polymer B has higher affinity than other dispersants with the acrylic-based polymer A as described above.

It is also observed that the dispersant concentration affects ink smear resistance. When second acrylic-based polymer B has a concentration less than 0.2 wt % in the pigment ink, no noticeable smear improvement is observed. On the other hand, when second acrylic-based polymer B has a concentration above 5 wt %, it is hard to maintain other ink properties and the printing results are undesirable. A proper concentration of polymer B in ink is from 0.2 to 5 wt %, and a preferred concentration is from 0.5 to 3 wt %.

Therefore, as discussed in detail above, Applicants have discovered that a two-part system can be used to improve the smear resistance of pigment-based inks on polymer-based photo paper. The first acrylic-based polymer A, can be used as a coating on polymer-based photo paper, or as a binder/additive in the ink receiving layer of polymer-based or porous photo papers. The second acrylic-based polymer B can be used as a dispersant in the pigment-based ink or just an additive with proper concentration and compatibility with other ink components. With some specific polymer properties, coating thickness and dispersant concentration range, acrylic-based polymers A and B have good compatibility with each other and provide strong binding force between the pigment-dispersant layer and the photo paper.

### EXAMPLES

The following examples are detailed descriptions of methods of preparation and use of the print media products of the present invention. The detailed descriptions fall within the scope of, and serve to exemplify, the more general description set forth above. The examples are presented for illustrative purposes only, and are not intended as a restriction on the scope of the invention.

### Example 1

One gelatin photo paper, Lemma Premium Gloss Photo Paper, and one color pigment ink set were chosen as control in this example. Then acrylic-based polymer A, Joncryl 660 Film Form Emulsion from Johnson Polymer, was coated on this gelatin paper. The coating thickness is about 10 μm. In addition, one acrylic-based polymer B, Joncryl HPD 671 (Acid Number 214NV, Tg 128° C. and MW 17,000), was used as an additive or dispersant in this pigment-based ink. As an additive, the concentration of Joncryl HPD 671 is 1 wt % in the ink. As dispersant, the concentration of Joncryl HPD 671 is 2 wt % in the ink.

These inks were printed on the control and coated photo paper, and the smear resistance was evaluated in 5 minutes (wet smear) and 24 hours (dry smear). In Table 3 below, numbers 1 to 5 were used to rank the smear resistance, where 1 indicates the best smear resistance. It is observed that the control pigment ink dries slow and has bad smear resistance. When the photo paper is coated with acrylic-based polymer A or when acrylic-based polymer B is used in the ink, the smear resistance is improved. The best smear resistance comes from a system that has 10 μm polymer A coated on the paper and 1-2 wt % polymer B added in the ink.

TABLE 3
Smear resistance ranking of pigment-based ink on gelatin photo paper.

| Joncryl 660 | Joncryl HPD 671 | Joncryl HPD 671 | Smear |
|---|---|---|---|
| Coating | Additive | Dispersent | Ranking |
| No | No | No | 5 |
| | 1 wt % | No | 3 |
| | No | 2 wt % | 2 |
| 10 μm | No | No | 3 |
| | 1 wt % | No | 2 |
| | No | 2 wt % | 1 |

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A two-part printing system comprising:
a) a substrate;
b) at least one print media supported by said substrate, said print media having an ink receiving layer comprised of a first acrylic based polymer A; and
c) a pigment-based ink jet ink composition comprising a pigment and a second acrylic-based polymer B.
wherein the acrylic-based polymers A and B act as a two part system to improve the smear resistance of the pigment-based ink composition when printed on the ink receiving layer of said substrate.

2. The two-part printing system of claim 1 wherein said substrate is a polymer-based photo paper.

3. The two-part printing system product of claim 2 wherein the first acrylic-based polymer A is an emulsion and has a molecular weight above 200,000, an acid number of from about 200 to about 250, and a Tg of from about −30° C. to 100° C.

4. The two-part printing system of claim 3 wherein the first acrylic-based polymer A is coated on the polymer-based photo paper.

5. The two-part printing system of claim 4 wherein the coating thickness of the first acrylic-based polymer A on the polymer-based photo paper is from about 5 μm to about 15 μm.

6. The two-part printing system of claim 1 wherein the second acrylic-based polymer B is water-soluble and has a molecular weight of from about 1,000 to about 20,000, an acid number of from about 200 to about 250, and a Tg from about 50° C. to about 150° C.

7. The two-part printing system of claim 6 wherein the second acrylic-based polymer B can be used as an acrylic dispersant or as an additive in the pigment-based ink composition.

8. The two-part printing system of claim 6 wherein the second acrylic-based polymer B comprises from about 0.2% to about 5% by weight of the pigment-based ink jet ink composition.

9. The two-part printing system of claim 8 wherein the second acrylic-based polymer B comprises from about 0.5% to about 3% by weight of the pigment-based ink jet ink composition.

10. The two-part printing system of claim 6 wherein the first acrylic-based polymer A is an emulsion and has a molecular weight above 200,000, an acid number of from about 200 to about 250, and a Tg of from about −30° C.

11. The two-part printing system of claim 10 wherein the first acrylic-based polymer A is coated on the polymer-based photo paper.

12. The two-part printing system of claim 11 wherein the coating thickness of the first acrylic-based polymer A on the polymer-based photo paper is from about 5 μm to about 15 μm.

13. The two-part printing system of claim 12 wherein the first acrylic-based polymer A and the second acrylic-based polymer B have a strong affinity for each other.
